(19) United States
(12) Patent Application Publication
(10) Pub. No.: US 2006/0118032 A1
(43) Pub. Date: Jun. 8, 2006

(54) Pressure indicator

(75) Inventor: Per Brandt Rasmussen, Augustenborg (DK)

Correspondence Address: MCCORMICK, PAULDING & HUBER LLP, CITY PLACE II, 185 ASYLUM STREET, HARTFORD, CT, 06103, US

(73) Assignee: Danfoss A/S, Nordborg (DK)

(21) Appl. No.: 10/559,597

(22) PCT Filed: May 28, 2004
(86) PCT No.: PCT/DK04/00374

§ 371 Date: Dec. 1, 2005

(30) Foreign Application Priority Data
Sep. 6, 1999 (GB) 99208852

(51) Int. Cl. G01L 19/12

(52) U.S. Cl. 116/270

(57) ABSTRACT

The invention provides an indicator for indicating a pressure difference. The indicator has a reference pressure chamber with two flexible wall parts being influenced to deflect upon pressures P1 and P2. The deflection of the wall parts changes a distance between each of the wall parts and an inflexible wall part of the chamber and by inspecting the difference, a pressure difference between P1 and P2 can be determined. To enable visual inspection, the chamber can be filled with an optically detectable fluid and one of the wall parts could be transparent to allow visual reading by determining a colour of the fluid layer below the transparent part.

### CROSS REFERENCE TO RELATED APPLICATIONS

This application is entitled to the benefit of and incorporates by reference essential subject matter disclosed in International Patent Application No. PCT/DK2004/000374 filed on May 28, 2004 and Danish Patent Application No. PA 2003 00817 filed Jun. 2, 2003.

### FIELD OF THE INVENTION

The present invention relates to a simple and reliable indicator which can be produced cheaply in very small sizes for an optical indication of a pressure difference. In particular, the invention relates to a pressure indicator for indicating a pressure difference between a pressure P1 of a first chamber and a reference pressure.

### BACKGROUND OF THE INVENTION

Pressure is typically indicated as a relative measure using standard units, e.g. bar, psi etc. In some applications, pressure sensors are inserted in a number of feed-lines to indicate a flow direction of a fluid medium. Often, such applications require no exact measure but merely an indication of the presence of a pressure difference over an element of the feed-line, e.g. indication of a pressure difference over a pump for detection of pump activity or indication of a pressure drop over a valve for detecting the state of the valve. In general, mechanical pressure sensors transform a pressure difference into mechanical movement of a scale or a pointer for a scale. The mechanical layouts of such sensors typically include one or more small, mechanically movable elements which are joined in bearings and mounted in a chassis which is large enough to house and protect the elements. Depending on the need for accuracy and reliability, all elements are machined within narrow tolerances and, accordingly, the cost for making traditional pressure sensors is high, not least for making very small sensors, e.g. for medical applications. Moreover, due to the mechanically moving elements, the reliability of traditional sensors may easily be influenced by external conditions such as changing temperatures or rough handling. To increase simplicity, indicators based on deflection of a wall part of a reference chamber have been developed. WO 01/18517 disclose a pressure sensor wherein a display diaphragm which is coupled to, and in fluid communication with an indicator diaphragm. A change in applied pressure causes relative movement between the diaphragms which is observable on an outer surface of the display diaphragm. Indicators of the disclosed kind are in general not suitable for determining low pressure differences, and often, it is difficult to read the visual display diaphragm.

### BRIEF SUMMARY OF THE INVENTION

It is an object of a preferred embodiment of the present invention to provide a pressure indicator which is simple to produce even with small outer dimensions and which can be more easily read even in low pressure applications. Accordingly, the present invention, in a first aspect, provides a pressure indicator of the kind mentioned in the introduction characterised in that the indicator further comprises a flexible third wall part separating the pressure chamber from a second chamber, the second chamber holding a pressure P2.

Due to the flexibility of the third wall part, increased sensitivity of the indicator can be obtained and it is therefore possible to read the indicator more clearly even in low pressure applications.

To increase simplicity in the reading of the indicator, one of the first, second or third wall parts could be made from a transparent material and the fluid could be optically detectable, e.g. coloured in an easily detectable colour such as red, blue, black etc. In this context, the wording “optically detectable” denotes a fluid which is detectable by its absorption and/or reflection of electromagnetic radiation in any wave length, e.g. a fluid which can be detected via X-ray, infra-red or visually in visible light. Since the deflection of the flexible wall parts causes a displacement of the optically detectable fluid, a pressure difference between the fluid medium and the reference pressure is detectable by observing the transparent wall part to detect e.g. the colour intensity, or an infrared or X-ray absorption. “Transparent” denotes that electromagnetic radiation of a specified wavelength can penetrate relatively freely. As an example, the fluid could be coloured to be visually detectable merely by looking at a transparent wall part, e.g. a wall part made of glass. In one embodiment, the first wall part could comprise a stiff plate element, e.g. made from a transparent material such as glass. The second and third wall parts could comprise a very thin and flexible membrane made from silicon or rubber to deflect upon even very small pressure differences.

To further facilitate easy reading of the indicator, the second and third wall parts could be arranged adjacent and substantially in parallel with the first wall part. A pressure difference between P1 and P2 would have the effect that the ratio between the distances “first wall to second wall” and “first wall to third wall” changes. If the first wall part comprises transparent portions located over both the second and the third wall parts, it is possible to read the indicator by determining a colour difference between the two transparent portions.

The pressure chamber may comprise a first compartment adjacent the second wall part and a second compartment adjacent the third wall part, the first and second compartments being in fluid communication via a connecting channel. Preferably, the pressure chamber is completely filled with a liquid incompressible substance, e.g. water or a gel or oil. Due to the incompressibility, the volume of the pressure chamber is kept constant. In this embodiment, the second wall member is allowed to deflect by deformation of the third wall part, and visa versa. In other words, the shape of the pressure chamber changes while the volume is constant. During the change in shape, the distance between the first and second wall parts changes and since the chamber is filled with an optically detectable fluid, the change in distance is optically visible by reading the “thickness” of the detectable fluid layer between the two wall parts.

The reference pressure is the internal pressure of the pressure chamber which acts on the second wall part and which thus counteracts P1. The reference pressure can be formed in many ways examples of which are:
The pressure chamber can be made to exert a certain counter force against deformation of its shape. As an example, the chamber can be made from a resilient rubber material which, during deformation of the second wall part, flexes under the exertion of a certain resistance,
the pressure chamber may form an upwardly extending open tube comprising a liquid column of the optically detectable fluid, which column provides the reference pressure,
the pressure chamber may be connected to a source of pressure, e.g. a compressor, e.g. via a throttling valve for adjusting the reference pressure,
the pressure chamber may be sealed with a mixed content of a liquid optically detectable fluid and a compressible gas,
the pressure chamber may simply have an opening towards the external pressure, e.g. the atmospheric pressure, or
the pressure chamber may have a third wall part of a flexible material, e.g. a very thin membrane, e.g. equal to the second wall part in size, shape and/or material and arranged to separate the pressure chamber from a second chamber holding a pressure P2. Inherently, this embodiment when combined with a pressure chamber filled with an incompressible fluid, results in counter phase movements of the second and third wall parts deflecting inwardly into the chamber or outwardly out from the chamber, respectively. Which of the surfaces deflect inwardly and which deflects outwardly depends on P1 relative to P2.

In any of the above described embodiments, the indicator can be made with means for adjusting the reference pressure, e.g. by adjusting the height if the liquid column, by adjusting a throttling valve, or by regulating the pressure P2.

The pressure indicator could be inserted in parallel with a pump, a valve or any other component of a feed-line wherein the intake and outlet sides of the component is connected to the first and second chambers, respectively. For use in such applications, it is of particular interest to make the second and third wall parts with equal characteristics, i.e. with same size, shape, thickness and of the same material and in particular so that application of equal pressures results in equal deflections of the second and third wall parts. In some applications, e.g. when P1 differs much from P2, the second and third wall parts could be made differently to balance partly or completely the expected differences between the two pressures, P1 and P2. As an example, the pressure indicator can be inserted in parallel with a high pressure pump which is designed to give a specific pressure difference between the intake and outlet side thereof. The pressure indicator may thus be designed with second and third wall parts which completely balance the pressure difference which the pump is supposed to provide. In this case, any malfunctioning of the pump leading to a higher or lower pressure difference can easily be detected by visual inspection of the optically detectable fluid between the first wall part and the second and third wall parts, respectively.

In order to allow easy detection of deflection of the second and the third wall parts simultaneously and furthermore to allow an easy and cheap manufacturing of the pressure indicator, the second and third wall parts may be formed in congruent planes, e.g. in one and the same wall of the pressure chamber. In order to further facilitate easy surveillance of the pressure indicator, the first wall part can be made from a transparent and preferably plane material, e.g. glass, arranged in a plane which is parallel to the planes of the second and third wall parts. The pressure indicator could be made in a three layers structure comprising two layers of glass arranged on each side of a layer of silicon. Prior to the assembling of the layers into one piece, a surface pattern forming the pressure chamber can be formed in a surface of the silicon layer while the opposite surface optionally is made with a surface pattern forming the first and second chambers, respectively. The surface structures of the silicon layer may be formed in micro-scale e.g. by etching.

After the assembling of the three layers, the pressure chamber is filled with the optically detectable fluid through a small hole and depending upon the principle for providing the reference pressure, the small hole may be sealed hermetically afterwards. The optically detectable fluid may preferably be a light absorbing fluid such as ink, e.g. a dark ink such as black, blue or red ink.

In medical applications, e.g. in connection with a medical dispensing apparatus, the pressure indicator may be used for detecting flow of a medical fluid. Even though the optically detectable fluid is encapsulated by the membrane, i.e. the second wall part, safety may be improved further by using an optically detectable fluid which is innoxious to living beings.

In order to make even small deflections of the second wall part and/or the third wall part visible, the thickness of the ink layer could be kept low. Accordingly, the distance between the first and the second wall parts may be chosen in the range of 5-100 μm. when the pressure difference is zero.

In a simple and reliable embodiment, the first wall part is inspected visually either by electrical detection means or simply by an operator looking at the outer surface of the first wall part. If the reflectivity of the surface or the colour of the surface changes, pressure change is indicated between the pressures of the pressure chamber and the first chamber, respectively. Analogously, if a third wall part and a second chamber exist, change between the reflectivity or between colour of areas above the second and third wall parts, respectively, indicates pressure changes between the first and second chambers respectively. In any case, if the indicator is inspected visually, it is required that the first wall part comprises a window which is permeable to visible light. The window should be placed above the second wall part, and with regards to embodiments of the invention which incorporate a third flexible wall part and a second chamber, the window should extend to cover also the third wall part or an additional window should be provided. The second and optionally third wall part(s) need not necessarily be transparent but could be made in a colour or reflectivity which is in contrast to the colour of reflectivity of the optically detectable fluid.

In order more easily to detect the displacement of the optically detectable fluid from the areas between the first wall part and the second wall part and optionally between the first wall part and the third wall part, the pressure indicator may have second and/or third wall parts which is/are substantially transparent, and optionally, a light source, e.g. an LED could be arranged on one side of the pressure chamber for projecting a beam of light through the second and/or the third wall part, through the optically detectable fluid and through the first wall member. In that way, it is easy to detect the distance between the wall parts by detecting the absorption of light through the pressure chamber.

In a preferred embodiment, an array of indicators according to the previous description is formed in a three layer structure comprising two glass layers arranged on each side of silicon layer. The silicon layer can be produced efficiently by use of etching and after assembling of three layers forming a large number of pressure indicators, the three layer structure may be split into units comprising a number of pressure indicators selected for a specific application.

In a second aspect, the invention provides a pump comprising an indicator according to the first aspect and attached to enable detection of pumping activity.

### BRIEF DESCRIPTION OF THE DRAWINGS

In the following, a preferred embodiment of the invention will be described in further details with reference to the drawing in which:

FIG. 1 shows a cross-sectional view of an optical pressure indicator according to the present invention,

FIG. 2 shows a preferred embodiment of a pressure indicator wherein pressure difference is detected via two flexible wall parts,

FIG. 3 shows a top view of the pressure indicator of FIG. 2,

FIG. 4 shows a top view of a pressure indicator with two indication windows for the reference fluid and one, centrally located window for the fluid medium,

FIG. 4a is a sectional view taken along line 4a-4a in FIG. 4,

FIG. 5 shows an array of pressure indicators, and

FIG. 6 shows an electrical sensor device arranged to detect colour or light intensity variations of the pressure indicator according to the invention.

### DETAILED DESCRIPTION OF THE INVENTION

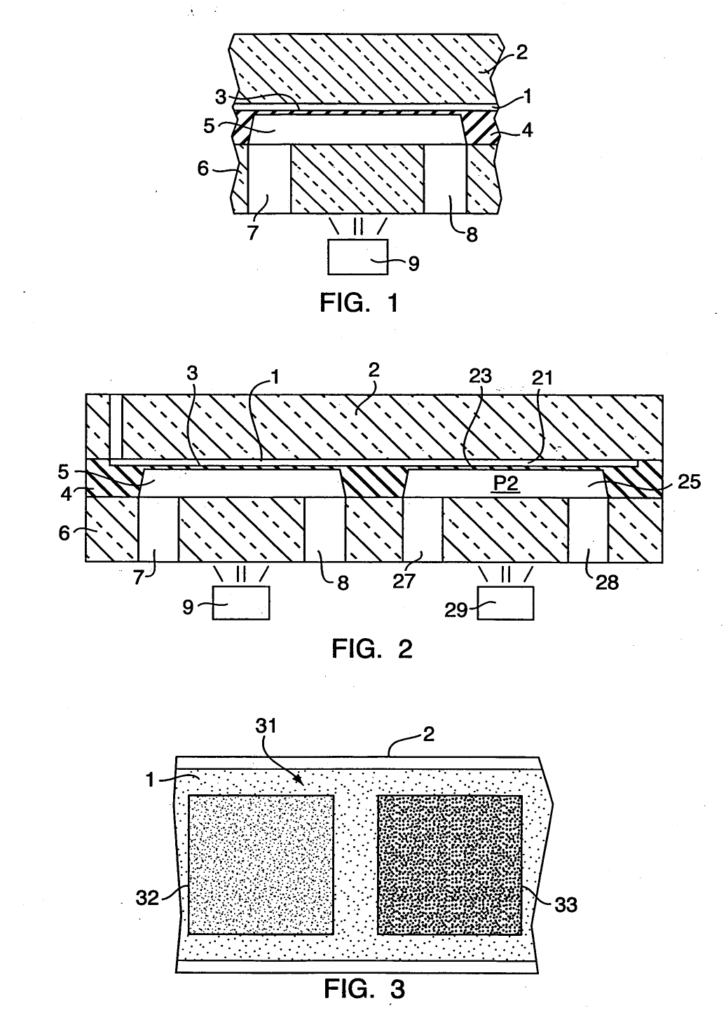

Referring to FIG. 1, the pressure indicator for detecting a pressure difference between a fluid medium and a reference pressure comprises a pressure chamber 1 having a first wall part 2 and a second wall part 3. The first wall part is transparent and could be made from a glass plate. The second wall part 3 is a flexible membrane formed by etching a part of a silicon plate 4 away. A first chamber 5 is separated from the pressure chamber via the flexible second wall part 3. Via the inflow and outflow channels 7, 8, the first chamber is in fluid communication with the fluid medium in question. The channels are formed in the plate 6, e.g. by drilling. Due to the arrangement of the flexible membrane between the pressure chamber and the first chamber, the membrane can be deflected either inwardly into the pressure chamber or outwardly out from the pressure chamber by a pressure difference between the internal pressure of the pressure chamber and the external pressure of the fluid medium in the first chamber. Due to the deflection, the distance between the glass plate 2 and the membrane 3 changes, and since the pressure chamber is filled with an optically detectable fluid such as a coloured liquid, e.g. ink, the change in the distance is optically detectable by detecting changes in absorption of light passing through the pressure chamber or by detecting a colour intensity of the fluid contained in the pressure chamber. In order to enable more easy detection of the changes in absorption of light or colour intensity, the pressure indicator can be made from layers of at least substantially transparent materials, e.g. a first layer forming the first wall part 2 made of glass, a second layer forming the second wall part 3 made as a very thin and thus partly transparent silicon membrane and a third layer 6 which could be made of glass, polyester, polycarbonate, polyacrylate, polymethacrylate etc. In order more easily to detect the colour intensity or absorption of light, a light source, e.g. an LED (light emitting diode), 9 can be fastened below the third layer to transmit light through the pressure chamber.

A preferred embodiment of a pressure indicator allowing an easier detection of pressure changes between a fluid medium and a reference fluid medium is disclosed in FIG. 2. In the pressure indicator shown in FIG. 2, the pressure chamber 1 is elongated with the part 21, which part comprises a third wall part 23 in the form of a flexible membrane. A second chamber 25 containing a fluid under a pressure P2 is arranged below the third wall part. The second chamber is in fluid communication with a fluid storage via the channels 27, 28. The light sources 9, 29 are optional. The filler hole 22 is provided merely for filling up the pressure chamber with the optically detectable fluid during making of the pressure indicator and may be sealed hermetically thereafter. When the filler hole is sealed, the pressure chamber is no longer in fluid communication with the surroundings. In this state, a pressure difference between the fluid media contained in the first and second chambers 5, 25, respectively, will cause deflections of the second and third wall parts in opposite directions inwardly into the pressure chamber or outwardly from the pressure chamber. As a result of the deflection, a difference between the colour and/or the light absorption may be inspected through the glass plate of the first wall part 2 above the second and third wall parts, respectively.

In FIG. 3 a pressure indicator of the kind disclosed in FIG. 2 is shown in a top view. The pressure chamber is filled with an optically detectable fluid in the form of a black ink. In the disclosed state, the pressure of the fluid medium which influences the second wall part (numeral 3 in FIGS. 1 and 2) is larger than the pressure of the reference fluid medium which influences the third wall part (numeral 23 in FIG. 2). Accordingly, the distance between the first wall part, i.e. the glass plate which covers the pressure chamber, and the second wall part is shorter than the corresponding distance between the first wall part and the third wall part. As it can be seen, the result is a light spot formed above the second wall part and a dark spot formed above the third wall part. The glass plate forming the first wall part (numeral 2 in FIG. 1) has a masked-off area 31 so that the black ink can merely be seen in the two well defined windows 32, 33 inside the masked-off area.

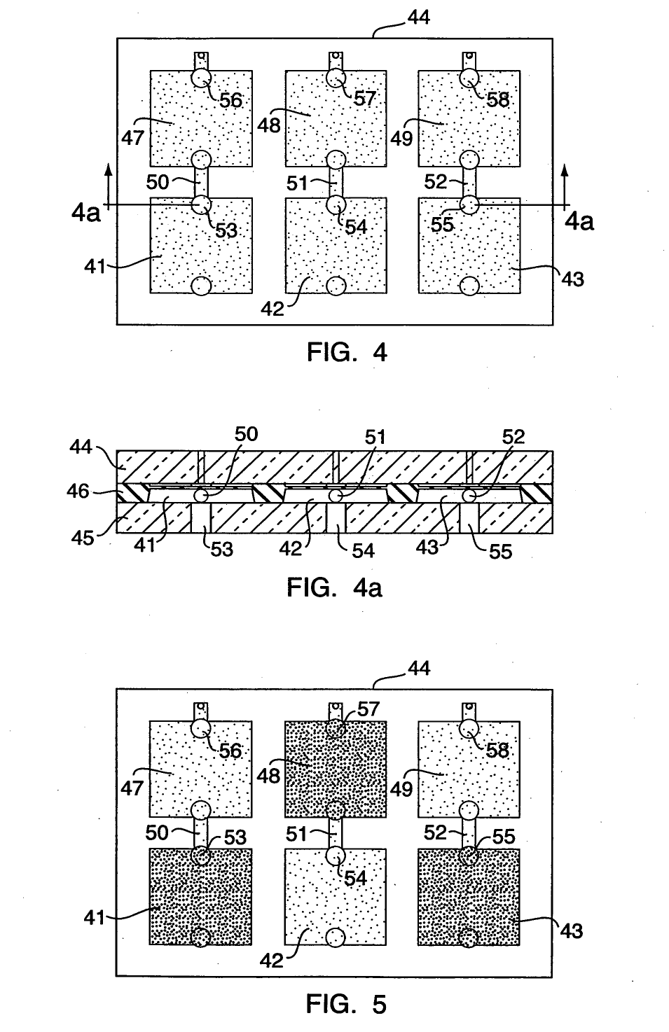

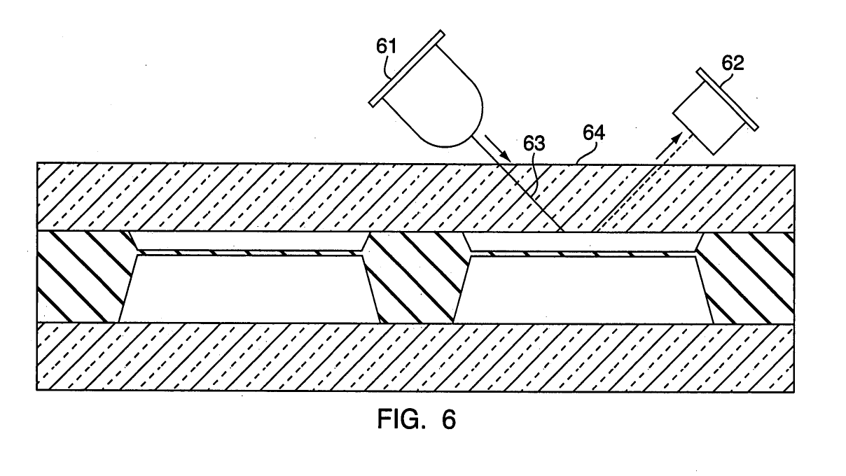

FIGS. 4 and 4a show a pressure indicator corresponding to the indicator shown in FIG. 3, wherein an array of 3 pressure indicators having 3 pressure chambers formed side-by-side in a single block having a three-layered structure, namely two glass layers 44, 45 on each side of a silicon layer 46. Each of the pressure chambers has first compartments 41, 42, 43 and second compartments 47, 48 and 49, the first compartments being in fluid communication with the second compartments via connecting channels 50, 51 and 52. The fluid and reference fluid media pressures are provided to the first and second chambers through the feeding channels 53, 54, 55 and 56, 57, 58, respectively. The feeding channels of one chamber, e.g. the feeding channels 53 and 56 can be connected on each side of a component of a fluid feed-line, e.g. on each side of a fluid pump, a throttle or similar. Via the pressure indicator, a user of the feed-line can validate whether the component in question lowers or raises the pressure of the feed-line, i.e. whether a pump, a throttle or similar component is activated. The arrangement of more pressure chambers side-by-side allows a user more easily to get an overview of a plurality of components of the feed-line. FIG. 5 shows a top view of the pressure indicator of FIG. 4 wherein the pressure at the feed-channel 53 is lower than the pressure at the feed-channel 56 and wherein the pressure at the feed-channel 55 is lower than the pressure at the feed-channels 58. This leads to a thick layer of optically detectable fluid in the first compartments 41 and 43 which hereby appear dark and to a thin layer of optically detectable fluid in the corresponding second compartments 47, 49 which hereby appears light, by displacement of fluid through connecting channels 50 and 52.

In the feed channel 54, pressure is higher than in the feed-channel 57. Hereby, optically detectable fluid is displaced from compartment 42 through connecting channel 51 into compartment 48. This leads to a thin layer of optically detectable fluid in the first compartment 42 which hereby appear light and to a thick layer of optically detectable fluid in the corresponding second compartment 48 which hereby appears dark.

A simple way of using the pressure indicator is simply by visually inspecting the outer surface of the first wall part to detect changes in reflectivity or colour of light reflected from the second and optionally third wall part(s). In FIG. 6, a pressure indicator with an electrical sensor is disclosed. The sensor comprises a transmitter 61 and a receiver 62. The transmitter transmits a signal 63, e.g. an electromagnetic signal, e.g. light onto the window 64 of the indicator. Depending upon the deflection of the membrane and thus upon the displacement of the optically detectable fluid, more or less of the transmitted signal is absorbed whereby the received signal, i.e. the signal which has been reflected by the surface of the membrane, is representative of the pressure difference between the pressure of the fluid medium and the reference pressure. In an alternative embodiment, the transmitter is arranged on an opposite side of the pressure indicator to transmit the signal through the pressure chamber.

While the present invention has been illustrated and described with respect to a particular embodiment thereof, it should be appreciated by those of ordinary skill in the art that various modifications to this invention may be made without departing from the spirit and scope of the present invention.

1-13. (canceled)

14. A pressure indicator for indicating a pressure difference between a pressure P1 of a first chamber and a reference pressure, said indicator comprising a sealed pressure chamber having a sidewall with an inflexible first wall part arranged at a distance from a flexible second wall part, the pressure chamber being completely filled with a fluid at the reference pressure, the second wall part being arranged to separate the pressure chamber from the first chamber and to deflect upon a pressure difference between P1 and the reference pressure, said deflection changing the distance between the first and second wall parts thereby displacing the fluid in the pressure chamber, the indicator further comprising a flexible third wall part separating the pressure chamber from a second chamber, the second chamber holding a pressure P2, wherein the first wall part is substantially transparent to electromagnetic radiation within a specific wave length, and where the fluid is an incompressible liquid substance.

15. The pressure indicator according to claim 14, wherein the pressure chamber comprises a first compartment adjacent the second wall part and a second compartment adjacent the third wall part, and a connecting channel providing fluid communication between the first and second compartments.

16. The pressure indicator according to claim 14, wherein the second and third wall parts have equal surface areas towards the first and second chambers, respectively.

17. The pressure indicator according claim 14, wherein the second and third wall parts have equal stiffness.

18. The pressure indicator according to claim 14, wherein the second and third wall parts extend in identical same planes.

19. The pressure indicator according to claim 18, wherein first wall part is arranged adjacent to, and in a plane which is parallel to the planes of the second and third wall parts.

20. The pressure indicator according to claim 19, further comprising illuminating means for projecting electromagnetic radiation within the specific wavelength from an outer side surface of the second wall part, through the second or third wall part, through the chamber and out of the chamber through the first wall part.

21. The pressure indicator according to claim 14, having a stacked configuration comprising a first layer made of glass and a second layer made of silicon.

22. The pressure indicator according to claim 21, further comprising a third layer made of glass.

23. The pressure indicator according to claim 22, wherein the first and third layers have substantially plane surfaces towards the second layer and the second layer has a first surface structure towards the first layer and a second surface structure towards the third layer, wherein the first surface structure forms the pressure chamber and the second surface structure forms the first chamber.

24. The pressure indicator according to claim 23, wherein the second wall part is formed integrally in the second layer.

25. An array of indicators comprising:
a plurality of indicators wherein each indicator indicates a pressure difference between a pressure P1 of a first chamber and a reference pressure, said each indicator comprises a sealed pressure chamber having a sidewall with an inflexible first wall part arranged at a distance from a flexible second wall part, the pressure chamber being completely filled with a fluid at the reference pressure, the second wall part being arranged to separate the pressure chamber from the first chamber and to deflect upon a pressure difference between P1 and the reference pressure, said deflection changing the distance between the first and second wall parts thereby displacing the fluid in the pressure chamber, the indicator further comprising a flexible third wall part separating the pressure chamber from a second chamber, the second chamber holding a pressure P2, wherein the first wall part is substantially transparent to electromagnetic radiation within a specific wave length, and where the fluid is an incompressible liquid substance; and wherein said array is formed in a three layer structure comprising two glass layers arranged on each side of silicon layer.

26. A pump with an inlet and an outlet, said pump comprising:
an indicator for indicating a pressure difference between a pressure P1 of a first chamber and a reference pressure, said indicator comprising a sealed pressure chamber having a sidewall with an inflexible first wall part arranged at a distance from a flexible second wall part, the pressure chamber being completely filled with a fluid at the reference pressure, the second wall part being arranged to separate the pressure chamber from the first chamber and to deflect upon a pressure difference between P1 and the reference pressure, said deflection changing the distance between the first and second wall parts thereby displacing the fluid in the pressure chamber, the indicator further comprising a flexible third wall part separating the pressure chamber from a second chamber, the second chamber holding a pressure P2, wherein the first wall part is substantially transparent to electromagnetic radiation within a specific wave length, and where the fluid is an incompressible liquid substance;
wherein said pump is arranged with the first chamber in fluid communication with the inlet and the second chamber in fluid communication with the outlet to obtain indication of pressure difference between the inlet and the outlet of the pump.
